(19) United States
(12) Patent Application Publication
(10) Pub. No.: US 2007/0083423 A1
(43) Pub. Date: Apr. 12, 2007

(54) Method and system for unmoderated content collaboration

(76) Inventor: David McClure Delbridge, Incline Village, NV (US)

Correspondence Address: DAVID MCCLURE DELBRIDGE, 572 ROCKROSE COURT, INCLINE VILLAGE, NV, 89451-8300, US

(21) Appl. No.: 11/245,899

(22) Filed: Oct. 6, 2005

(51) Int. Cl. G07C 13/00

(52) U.S. Cl. 705/12

(57) ABSTRACT

This invention discloses a method and system for computer-based, unmoderated content collaboration among a community of users. A network server (101) holds a host application (103) (e.g., Internet website) and content. The host application (103) permits a community of users at network clients (102) (e.g., Internet web browsers (114)) to view the content and submit modification requests. These requests are reviewed and voted upon by other users. In accordance with the election results, the provisions of a request are automatically incorporated into the content by the host application (103) without approval or implementation by a moderator.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates generally to computer-based collaboration, and more particularly, to a method and system for unmoderated content collaboration.

2. Prior Art

Existing methods of computer-based content collaboration commonly employ moderators to police users and their activities.

One of the most common methods of content collaboration employs a moderator to maintain a closed community of only trusted users. Because every user has been pre-screened for trustworthiness, their individual modifications to the content may be implemented with little or no moderation. Existing methods and systems for collaboration that do not specify an integral security or quality control component are typically deployed in this context.

An example of this method is demonstrated by IBM's Lotus Notes groupware application, wherein users gain access to a shared content database by permission of a moderator.

This method has several drawbacks. First, prospective users must be screened for trustworthiness before access to the collaborative community may be safely granted. Such screening, while manageable for smaller and less-dynamic user communities, may present an overwhelming burden for moderators of larger collaborative communities, such as those driving “open” Internet development projects, like The Open Directory Project, which has tens of thousands of contributing collaborators. Second, a closed community must be made inaccessible to untrusted users, such network security posing a considerable and expensive endeavor in itself. Third, a moderator is nonetheless required to manage occasional user disputes and misconduct. Fourth, this method is not inherently fair or democratic, being that the moderator's personal preferences and prejudices can influence or directly determine member selection.

A second existing method of content collaboration employs a moderator to oversee, approve, or even implement individual content modification requests submitted by users. This method allows for open communities, whereby user membership is not moderated.

An example of this method is demonstrated by the Debian Project's GNU/Linux open source operating system, wherein hundreds of volunteers from around the world submit content modifications to a moderator for approval and implementation.

This method also has several drawbacks. First, the volume of content modification requests that can be supported is limited by the availability of moderators. In larger communities, modification requests may go unanswered for days, weeks, or indefinitely. As such, open communities can become unsustainable due to their popularity: an unfortunate paradox. Second, the expertise of a moderator would be better spent contributing to the content, rather than managing the requests of subordinate, less-skilled collaborators. Third, this method is not inherently fair or democratic, being that the moderator has the authority to accept or reject each content modification request, regardless of popularity with users.

A third existing method of content collaboration employs no moderators, instead allowing a community of wholly untrusted users to police themselves. An “undo” feature may allow for quick recovery of quality content.

An example of this method is demonstrated by Wikipedia and other “Wiki” web sites, which permit open modification of collaborative content by any user.

Unfortunately, this method relies on a flawed premise: that a sufficient number of users in an open, collaborative community will be both trustworthy and charitable enough to correct the errors of others. In practice, this method has proven to be unreliable, particularly where the content's subject matter evokes emotional debate. With no means to restrain users, the collaborative content can become a battlefield for conflicting viewpoints or a target for outright vandalism.

To summarize, all systems and methods for content collaboration heretofore known suffer from a number of disadvantages:
(a) those employing a moderator are limited in scope to communities of a size and activity level manageable by the moderator;
(b) those employing a moderator are susceptible to moderation processing delays;
(c) those employing a moderator often require but provide for no security beyond that of the moderator;
(d) those employing a moderator are neither inherently fair nor democratic;
(e) those employing a moderator consume the moderator's time;
(f) those employing a moderator often underutilize the moderator's expertise;
(g) those employing no moderator provide insufficient security and quality controls;
(h) those employing no moderator are susceptible to counter-productive behavior;
(i) those employing no moderator are susceptible to vandalism.

3. Objects and Advantages

It is therefore an object of the invention to provide a method and system for unmoderated content collaboration.

It is another object of the invention to provide a method and system for content collaboration that frees moderators from the burden of moderating users and their activities.

It is another object of the invention to provide a method and system for content collaboration that affords moderators the time to apply their expertise to the respective collaborative content.

It is another object of the invention to provide a method and system for content collaboration whereby content modifications are implemented automatically, without approval or implementation by a moderator.

It is another object of the invention to provide a method and system for content collaboration that processes content modification requests more expeditiously than may be achieved by moderated alternatives.

It is another object of the invention to provide a method and system for content collaboration whereby content modifications are nominated and elected by its users.

It is another object of the invention to provide a method and system for content collaboration that can support user communities of unlimited size, like those found in “open” Internet development communities.

It is another object of the invention to provide a method and system for content collaboration that is openly accessible, such that any user may participate.

### SUMMARY OF THE INVENTION

In accordance with the present invention, there is provided a computer-implemented method and system for content collaboration having a host application and content on a network server such that users at network clients may nominate and elect modifications to the content without approval or implementation by a moderator.

### DRAWINGS—FIGURES

FIG. 1 is a block diagram illustrating the components of a preferred embodiment of the invention.

FIG. 2 is a conceptual diagram of a portion of a database table containing collaborative content data.

FIG. 3 is an image diagram of the screen of a client computer displaying a portion of the rendered collaborative content.

FIG. 4 is an image diagram of the screen of a client computer displaying a modification request form.

FIG. 5 is a conceptual diagram of a portion of a database table containing modification request data.

FIG. 6 is an image diagram of the screen of a client computer displaying a content modification e-mail alert message received at an e-mail client application.

FIG. 7 is a conceptual diagram of a portion of a database table containing modified collaborative content data.

FIG. 8 is an image diagram of the screen of a client computer displaying a portion of the rendered, modified collaborative content.

FIG. 9 is a flowchart illustrating the operational procedure of a preferred embodiment of the invention's method.

FIG. 10 is a flowchart illustrating the operational procedure for validating a modification request for compatibility with a preferred embodiment of the invention's method.

### REFERENCE NUMERALS

101 network server
102 network client
103 host application
104 collaboration database
105 content rendering system
106 modification request system
107 polling system
108 modification implementation system
109 messaging system
110 web server
111 messaging server
112 server network interface
113 client network interface
114 web browser
115 messaging client
116 Internet
201 database table—collaborative content data
202 database table column—collaborative terms
203 database table column—collaborative definitions
204 database table column—unique table record IDs
301 rendered content—collaborative “Terms”
302 rendered content—collaborative “Definitions”
303 rendered content—non-collaborative subhead
401 modification request form
402 modification request form field—content target
403 modification request form field—replacement content
501 database table—modification request data
502 database table column—relational pointer to target content
503 database table column—replacement content
504 database table column—expiration date
505 database table column—election status
506 database table column—unique table record IDs
601 content modification alert
602 content modification alert—target content
603 content modification alert—replacement content
604 content modification alert—voting button—accept
605 content modification alert—voting button—reject
701 database table, modified—collaborative content data
702 database table field—target content
703 database table field—replaced content
801 rendered content—target content
802 rendered content—modified content
901 action—user submits content modification request
902 decision—is request acceptable?
903 action—reject request
904 action—publish request for review
905 decision—is voting period over?
906 action—users discuss request
907 action—users submit votes
908 action—calculate voting results
909 decision—is request elected?
910 action—reject request
911 action—implement requested modification
1001 action—user submits modification request
1002 decision—is request complete?
1003 action—reject request
1004 decision—are field values too long?
1005 action—reject request
1006 decision—do field values contain illegal characters?
1007 action—reject request
1008 decision—does target content exist?
1009 action—reject request
1010 decision—do pending requests exist against target?
1011 action—reject request
1012 action—accept request

### DETAILED DESCRIPTION

### Preferred Embodiment

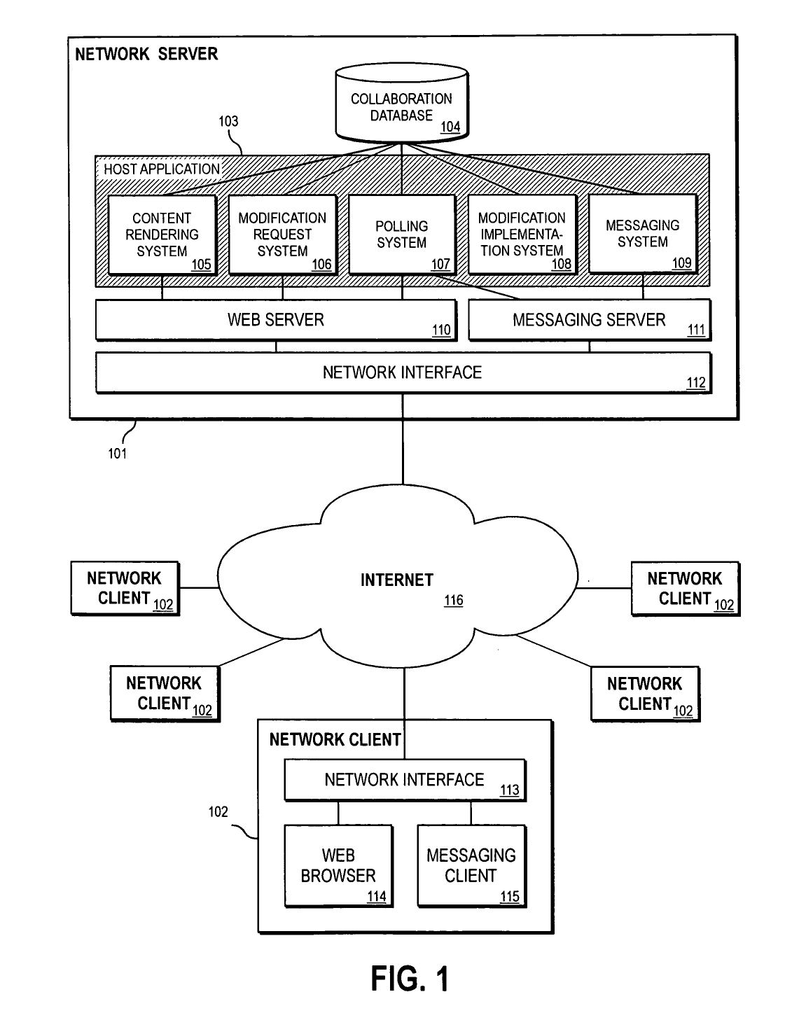

FIG. 1 illustrates a preferred embodiment of the invention's system and includes components 101 through 116. Except where specified, components employ general-purpose computer hardware and software.

A network server 101 with network interface 112 is connected to network interfaces 113 of network clients 102 by way of a network or interconnected networks; in this case, the Internet 116.

The network clients 102 may be general-purpose computers, such as those running Microsoft's Windows or Apple's Mac OS operating systems, or handheld computers such as those running Microsoft's Windows CE operating system, or portable PDAs (Personal Digital Assistants), such as those running Palm Computing's PalmOS operating system, or cellular telephones or, for that matter, any device with a compatible Internet web browser 114 and messaging client 115.

Network connections may be wired, such as by Ethernet cables, or may be wireless, such as by The Wi-Fi Alliance's WiFi (Wireless Fidelity) or CDPD (Cellular Digital Packet Data).

The network server 101 contains a host application 103 and a collaboration database 104. The host application 103 is a computer program or collection of programs developed using an API (Application Programming Interface), such as Microsoft's ASP (Active Server Pages), Macromedia's ColdFusion, or the open source PHP (PHP Hypertext Preprocessor). The API enables the host application to interface with the database 104 and to communicate with clients 102 via the public-facing web server 110 and public-facing messaging server 111.

In the preferred embodiment, the messaging server 111, messaging system 109 and messaging clients 115 employ standard e-mail protocols (e.g., POP3, SMTP).

It should be clear to one skilled in the art that the functions performed by components 103, 104, 110, and 111 may be performed by a single server or more, separate servers.

In the preferred embodiment, the host application 103 performs five distinct functions. For clarity, these functions are illustrated by five distinct software component systems 105-109. However, such organization of program code and functions need not be strictly followed.

Likewise, the program logic employed in each of these software component systems is predetermined by the system's implementers in accordance with the requirements of the collaborative content. Though not illustrated in the preferred embodiment, many forms of content are compatible with the invention and will influence its program logic accordingly. Hence, specific program instructions are neither integral to the invention nor implied.

The content rendering system 105 presents, on demand, the current state of the content to a client's web browser 114 by way of predetermined program logic and content data stored in the collaboration database 104. A useful analogy for understanding the process of content rendering is a mail merge, whereby a word-processor represents the system's program logic and merged addresses represent the system's collaborative content data. With this data, the content rendering system 105 renders the complete and current content to the client's web browser 114.

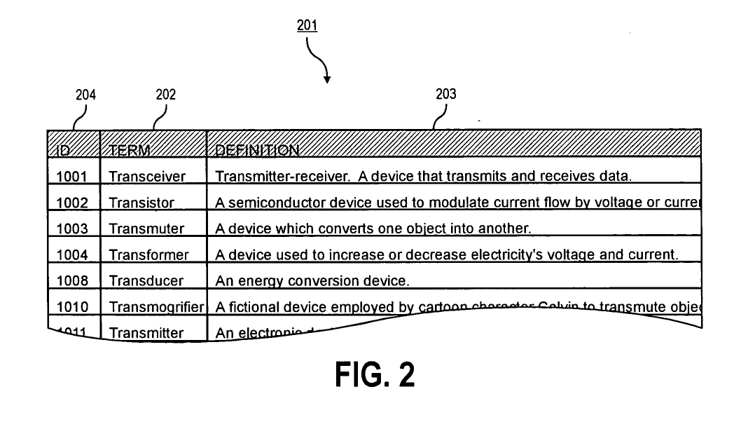

Sample collaboration data is illustrated in FIG. 2. A collaborative content database table 201 holds the collaborative terms 202 and respective collaborative definitions 203 for the sample content, a “dictionary of technical terms.” Each database table record is assigned a unique identifier 204 by the database 104 for routine database operations, such as locating and removing individual records.

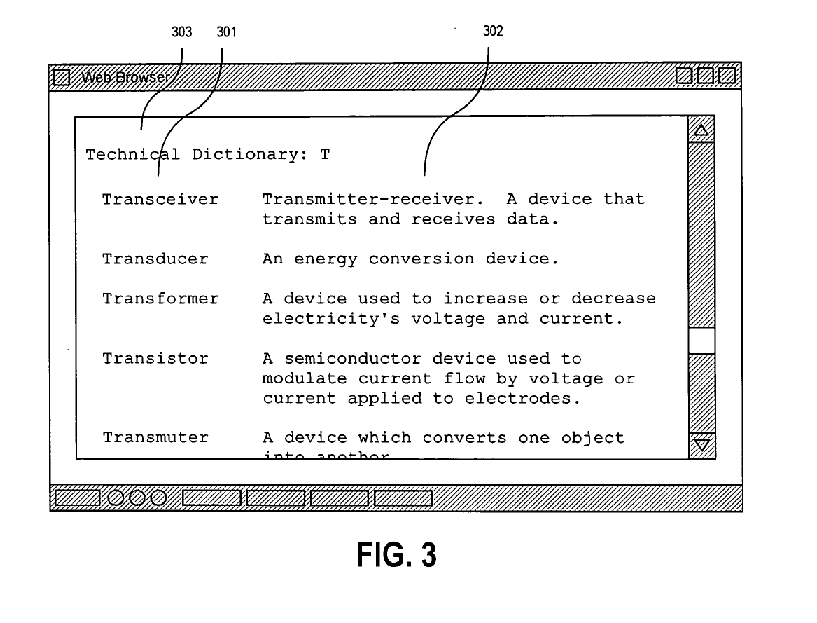

Sample rendered content, as displayed in the client's web browser, is illustrated in FIG. 3. The dictionary terms 301 and respective definitions 302 have been queried from table 201, then alphabetized and formatted by the program logic of the content rendering system. Other content components, such as the sample subhead 303, are non-collaborative and also generated by the predetermined program logic of the content rendering system 105.

Returning to FIG. 1, the modification request system 106 presents, on demand, a modification request form to the client's web browser 114. The system receives and validates the modification request form input data. Validated requests are given a calculated expiration date and stored in the database 104 for later retrieval by the polling system 107 and modification implementation system 108.

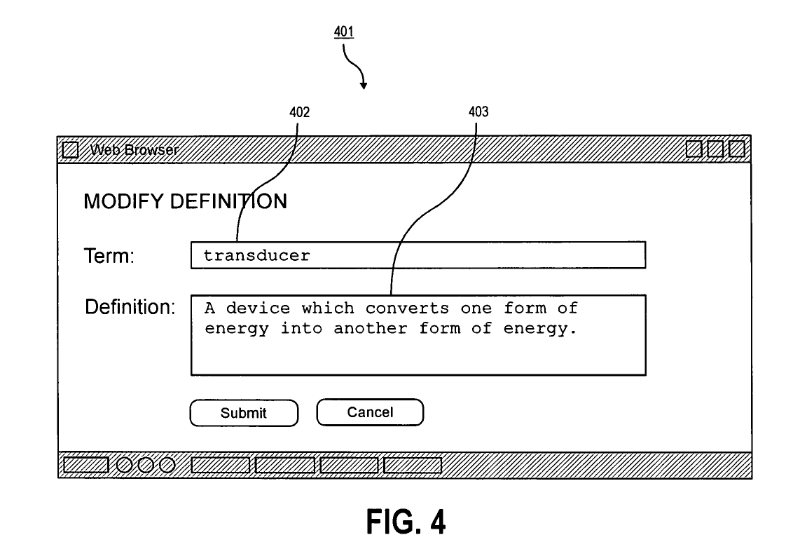

A sample modification request form, as displayed in the client's web browser, is illustrated in FIG. 4. Form fields prompt the user for a content target 402 to be modified and replacement content 403.

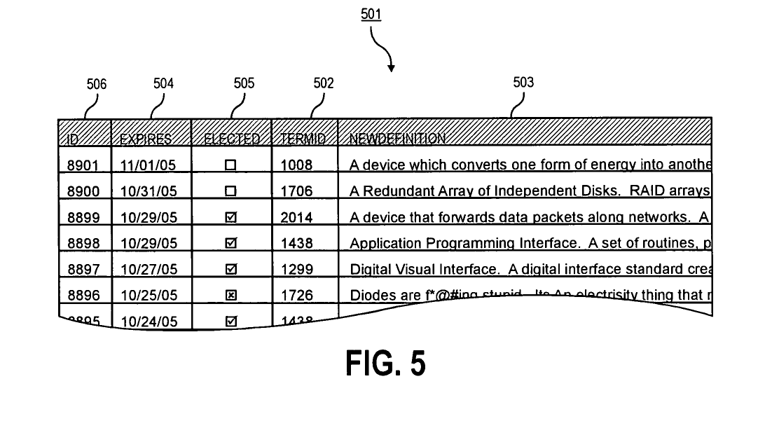

Sample modification request data, as stored in the database 104 after validation, is illustrated in FIG. 5. A database table 501 holds, for each modification request, a relational pointer to the request's target content 502 of the collaborative content database table 201, along with the respective replacement content 503. An expiration date 504 indicates the last day of the request's polling period, which is used by the polling system 107 to terminate the request's voting. An election status flag 505 indicates whether the request is pending (e.g., empty), accepted (e.g., checkmark), or rejected (e.g., x-mark). Each database table record is assigned a unique identifier 506 by the database 104 for routine database operations, such as locating individual records.

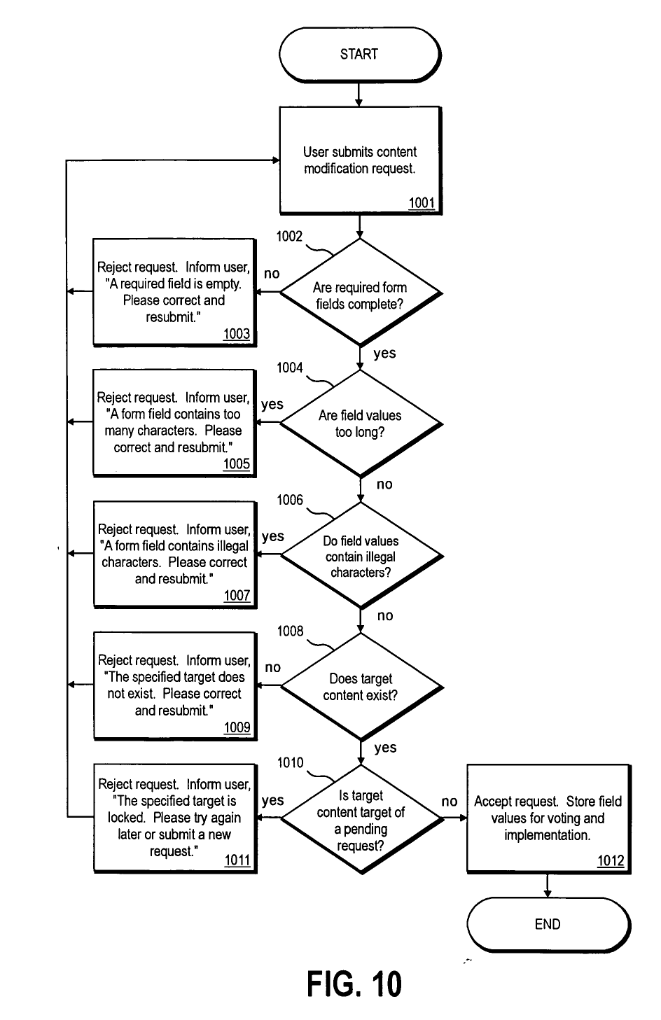

The method of validation employed in the preferred embodiment is illustrated in FIG. 10 and will be described later in this specification.

In the preferred embodiment, the modification request system 106 accepts three distinct modification types, so that users may collaboratively add content, replace content, and remove content, respectively. For example, the sample modification request form illustrated in FIG. 4 demonstrates a modification request of type ‘replace content,’ wherein the “Term” field 402 is used to specify the target content to be replaced and the “Definition” field 403 is used to specify the proposed replacement content. For conciseness, the other two modification types are not described in this specification. However, it should be understood that, for each modification type, there is a respective modification request form, input validation logic, polling logic and implementation logic in the host application.

Returning to FIG. 1, the polling system 107 manages pending requests. At regular intervals, the polling system 107 checks the request table 501 for new requests. For each new request, the polling system 107 generates messaging alerts through the server's messaging server 111 to the user's messaging client 115.

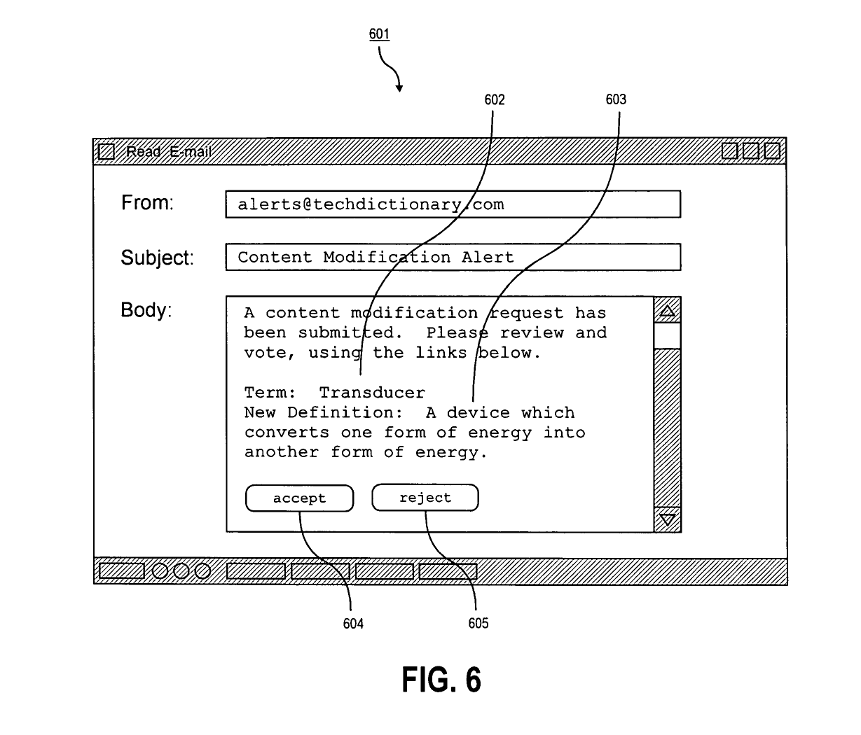

A sample messaging alert, as displayed in the client's messaging client 115, is illustrated in FIG. 6. The target content 602 and proposed replacement content 603 recite the modification parameters as submitted in the original modification request 401, in fields 402 and 403, respectively. Voting buttons permit the user to accept 604 or reject 605 the modification request, and indicate that the depicted messaging client supports HTML-embedded messages, as described below.

Returning to FIG. 1, the alert directs users to a voting form on the server's web server 110. In the preferred embodiment, messaging clients 115 that support HTML-embedded messages can present the voting form natively for immediate voting from within the messaging client 115. The polling system 107 receives, validates and stores votes into the database 104 for future calculation of voting results.

At regular intervals, the polling system 107 checks the requests table 501 for expired polls. When the request's expiration date is reached, the polling system 107 closes polling for the request and calculates the voting results. If elected, the request is flagged in the election status field 505 of the modification requests table 501 for implementation by the modification implementation system 108.

At regular intervals, the modification implementation system 108 checks the requests table 501 for newly elected requests. For each such request, the modification implementation system 108 retrieves the target content pointer 502 and replacement content 503 of the elected modification request from the modification requests table 501 and implements them into the collaborative content database table 201 such that subsequent retrieval of the content through the content rendering system 104 incorporates the elected modification.

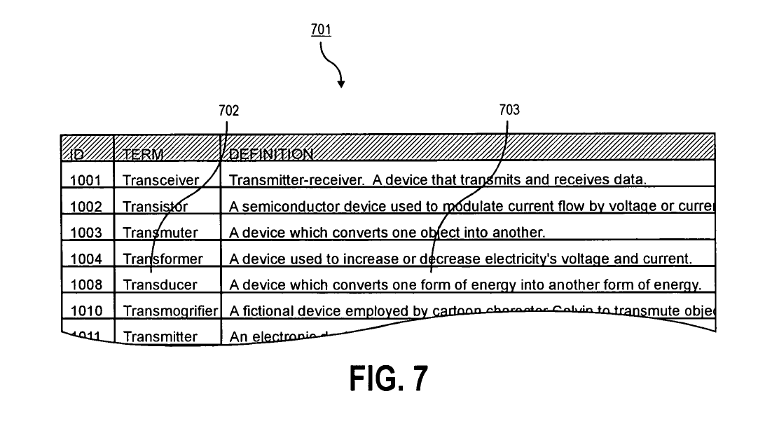

FIG. 7 illustrates the content data table of FIG. 2 after receiving the elected modification. The target term, “Transducer” 702 contains a new definition 703, as was specified in the original modification request 401.

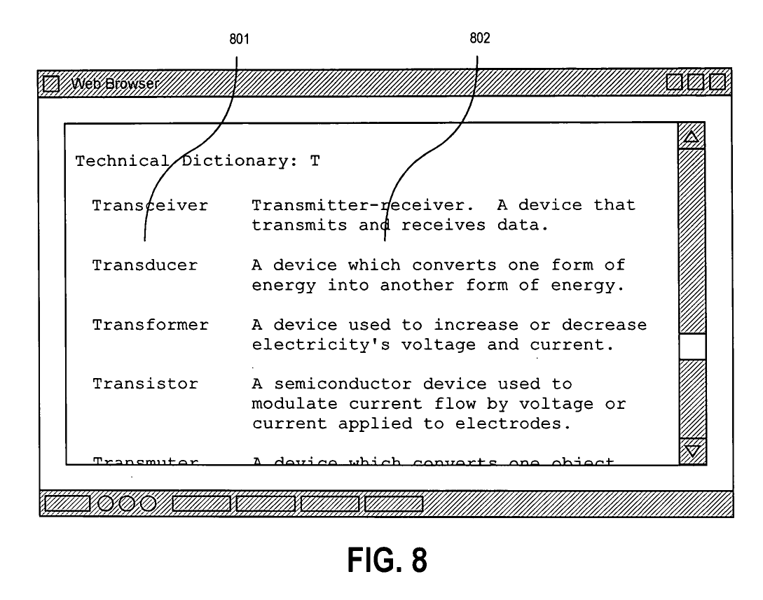

FIG. 8 illustrates the resulting rendered content as displayed in the client's web browser 114, according to the modified collaborative content database table 701. Specifically, the target content 801 displays a modified definition 802, per the collaborative content database table 701, target content field 702 and replaced content field 703, respectively.

Returning to FIG. 1, the messaging system 109 provides an asynchronous discussion mechanism for users in the form of a dynamic ListServ. Replies to a modification request alert, such as that illustrated in FIG. 6, are received and processed by the messaging system 109 and then forwarded to other alertees. Likewise, replies to those replies are handled in the same manner, and so on, allowing for group discussion of a pending request by way of standard e-mail messages.

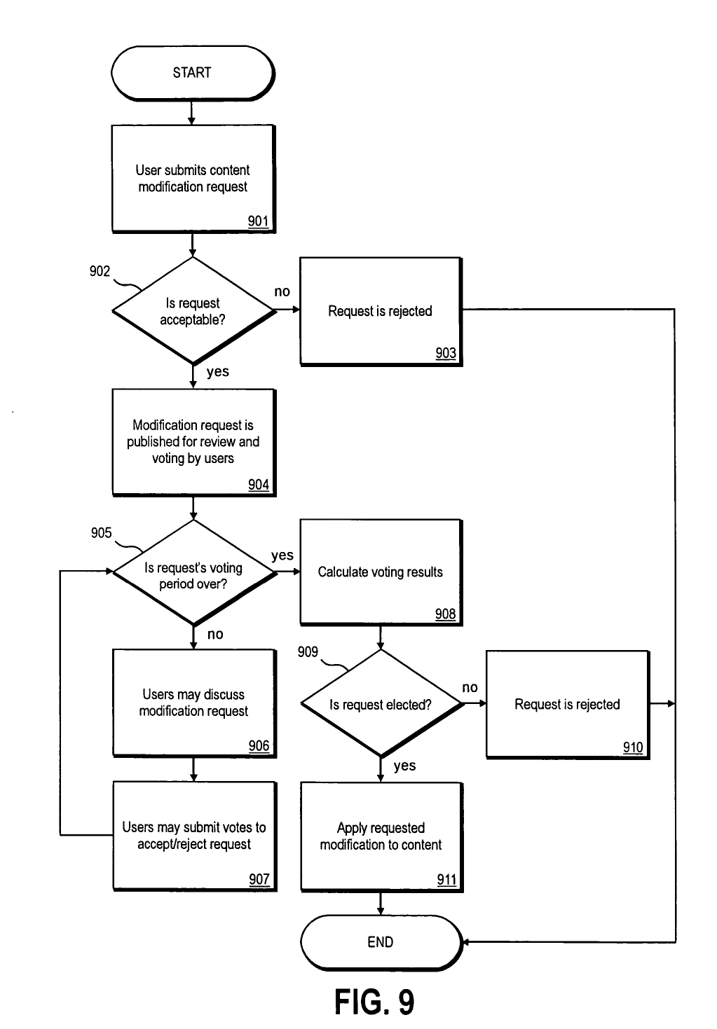

FIG. 9 illustrates the operational procedure of a preferred embodiment of the invention's method and includes steps 901 through 911. First, a user submits a content modification request form 401 to the host application 103, step 901.

Next, the host application 103 validates the user-supplied input data for compatibility, step 902, to ensure that the request will be interpretable and implementable by the host application's program logic. If incompatible, the request is rejected and the user notified, step 903. If determined to be compatible, the request is published for review and voting by users, step 904.

Next, the host application 103 administers a polling term, step 905, allowing time for users to receive and consider the request, to discuss the request, step 906, and to submit votes, step 907.

When the request's polling term expires, the host application 103 closes the poll and calculates the voting results, step 908, and determines the results of the poll, step 909. If rejected, no further action is taken, step 910. If accepted, the host application implements the request's modifications into the content, step 911.

By this method, modifications to the content are democratically elected and automatically incorporated into the content without approval or implementation by a moderator.

FIG. 10 illustrates the method for validating a sample modification request in the preferred embodiment and includes steps 1001 through 1012.

This particular validation method applies to a modification of type ‘replace content.’ Validation methods for other modification types, such as ‘add content’ or ‘remove content’ employ similar but not identical validation methods. For conciseness, those methods are not illustrated in this specification.

First, a user submits a modification request form 401, step 1001.

Next, the host application 103 verifies that each required form field contains input data, step 1002. If any of the required form fields are empty, the request is rejected, step 1003. Otherwise, an empty form field could produce an error in the host application, requiring corrective action by a moderator.

Next, the host application 103 verifies that the form field data does not exceed predetermined character-length limits pre-assigned to each field, step 1004. If any of the required form fields contain too many characters, the request is rejected, step 1005. Otherwise, excessive form field data could produce a buffer overflow or become concatenated, either instance requiring corrective action by a moderator.

Next, the host application 103 verifies that the form field data contains no illegal characters, step 1006, whereby illegal characters are defined to be any unexpected character or any character or combination of characters known to be incompatible with the host application 103. If any form field contains illegal characters, the request is rejected, step 1007. Otherwise, one or more illegal characters could produce an error in the host application, requiring corrective action by a moderator.

Next, the host application 103 verifies that the specified target for modification exists in the collaborative content, step 1008. If the target content is found to be non-existent, the request is rejected, step 1009. Otherwise, the host application 103 could produce an error, requiring attention by a moderator.

Next, the host application 103 verifies that the target of modification is not the target of other, pending modification requests, step 1010. If the target content is found to be the target of another, pending modification request, the new request is rejected, step 1011. Otherwise, the preceding modification, if elected, could render the secondary modification unimplementable, such as by a preceding request to remove the target content. If elected, the secondary request would then target non-existent content, producing an error in the host application 103, requiring the attention of a moderator.

Lastly, having passed all of the preceding validation tests, the request is deemed compatible with the host application 103 and accepted for processing, step 1012.

By this method, content modification requests are verified to be compatible with the host application 103 and, consequently, may be elected and incorporated into the content without approval or implementation by a moderator.

### Alternative Embodiments

Another embodiment of the invention incorporates no messaging component. Pending modification requests are available to users for review and voting in the host application alone.

Another embodiment of the invention incorporates no database, instead storing the collaborative content in a flat file. The host application incorporates additional program logic to manage the flat file. In this manner, the embodiment is compatible with pre-existing and common content file formats, such as those employed by popular word-processing applications. Elected modifications are implemented into the content by the host application, according to the requirements of the respective file format.

Another embodiment of the invention accepts modification requests submitted by way of electronic messaging. The host application receives the message, parsing the required parameters from the message subject and body. The request is then processed as described in the preferred embodiment.

Another embodiment of the invention's system incorporates user permissions in the host application to control access to certain modification request types. User permission data is made to be collaborative content through the addition of respective database tables and two new modification types, “promote user” and “demote user.” In this manner, a trust-based security system is realized, whereby users earn privileges from their peers for contributions made to the content. Likewise, users who perform poorly may be prevented by their peers from introducing further modifications to the collaborative content.

Another embodiment of the invention incorporates nomination requests, whereby modifications are nominated by users prior to election. As such, the host application presents nomination ballots with open-text input fields and resultant election ballots with multiple candidate modifications to elect from.

Another embodiment of the invention incorporates dynamic revoting, whereby multiple candidate modifications are eliminated through successive votes, until a final modification is elected for implementation.

Another embodiment of the invention incorporates weighted voting, whereby votes submitted by a trusted user possess additional influence over those of other, less-trustworthy users.

Another embodiment of the invention incorporates different sample content and, accordingly, different modification request types. In this embodiment, the sample content comprises a collaborative multimedia encyclopedia, with subjects, paragraph text and media clips. Additional database tables and program logic are incorporated into the server to support the content and its respective modification request types: add subject, replace subject title, remove subject, add paragraph, replace paragraph, move paragraph, remove paragraph, add media, replace media, move media, remove media. Non-collaborative elements include: title text, page formatting, text formatting and media formatting.

This embodiment demonstrates that the invention supports many forms of collaborative content, including without limitation, content containing one or more of any of:
(a) a readable text,
(b) a viewable image or moving image,
(c) a listenable audio recording,
(d) a machine-executable instruction,
(e) machine-readable data.

Furthermore, it should be obvious to one skilled in the art that the collaborative content may begin as or become through collaborative modification a null, zero-length or otherwise blank value. In other words, the content need not “contain” any data.

Another embodiment of the invention's system employs text messaging (e.g., IRC protocol) electronic messaging components. In contrast to the asynchronous e-mail messaging components described in the preferred embodiment, text messaging generates real-time alerts, discussions and voting for pending modification requests and, consequently, realizes a synchronous unmoderated collaboration system.

### Advantages

From the description above, a number of advantages of the system and method for unmoderated content collaboration become evident:
(a) The host application, which manages content modification requests for a collaborative community, obviates the need for a human moderator.
(b) By obviating the need for a human moderator, would-be moderators are freed from the burden of managing content modification requests for a collaborative community.
(c) By obviating the need for a human moderator, would-be moderators are afforded the time to apply their expertise to the respective collaborative content.
(d) The host application implements elected modifications automatically, without requiring approval or implementation by a moderator.
(e) Elected modifications are implemented expeditiously, being that they need not await a moderator for approval or implementation.
(f) Modifications to the collaborative content are nominated and elected fairly by users.
(g) Unhindered by human moderation, the network-based host application can support user communities of any size, like those found in “open” Internet development communities.
(h) In addition to the primary collaborative content, user privileges can also be made the target of public election in the network-based host application, thereby realizing a trust-based security model, allowing for a community that is openly accessible, such that any user may participate.

### Conclusion, Ramifications, and Scope

Accordingly, the reader will see that the method and system of this invention allow users to collaborate upon an instance of content without moderation.

Furthermore, the method and system have the additional advantages in that:
(a) it obviates the need for a moderator in a collaborative community;
(b) it frees would-be moderators from the burden of managing content modification requests for a collaborative community;
(c) it affords would-be moderators the time to apply their expertise to the respective collaborative content;
(d) it implements elected modification requests automatically, without requiring approval or implementation by a moderator;
(e) it implements elected modifications expeditiously, without awaiting approval or implementation from a moderator;
(f) it implements modifications fairly per popular election;
(g) it supports user communities of any size, like those found in “open” Internet development communities.
(h) it allows for a collaborative community that is openly accessible, such that any user may participate.

While the above description contains many specificities, these should not be construed as limitations on the scope of the invention, but rather as an exemplification of some of the presently preferred embodiments thereof. Many other variations are possible.

Namely, the invention can support many forms of collaborative content, including, for example and without limitation:
(a) an index of Internet websites, managed by Internet users, worldwide;
(b) an open-source computer program, continually improved upon by contributions of program code;
(c) a dynamic encyclopedia, incorporating all points-of-view;
(d) an educational text, updated continually for emerging science/technology;
(e) a community-improvement plan, whereby citizens elect and prioritize projects;
(f) an amendable constitution of laws or taxonomical model of government;
(g) a news or entertainment magazine, featuring editorial contributions;
(h) a technical document comprised of tips deemed most useful by users;
(i) a movie, television or stage script;
(j) a musical composition created by contributions of recorded audio clips;
(k) a work of art, built from artist contributions.

Thus, the scope of the invention should be determined by the appended claims and their legal equivalents, rather than by the examples given.

What is claimed is:

1. A computer-implemented method for unmoderated content collaboration, comprising the steps of:
(a) providing a means for requesting a modification to said content by a user,
(b) providing a means for voting on the modification request by a multiplicity of users,
(c) calculating an election result from said voting,
(d) applying said modification to said content in accordance with said election result,
whereby said content, in accordance with said election result, receives said modification without approval or implementation by a moderator.

2. The method of claim 1, further including the step of rejecting said modification request when said modification request is determined to be incompatible with any other step of said method.

3. The method of claim 1 wherein the step of providing a means for voting includes administering a voting period, whereby said voting period commences and terminates, without implementation by a moderator.

4. The method of claim 1 wherein the step of providing a means for voting includes alerting said multiplicity of users to said modification request.

5. The method of claim 1 wherein the step of providing a means for voting includes providing a means for discussing said modification request among said multiplicity of users.

6. The method of claim 1 wherein said content comprises one or more of the following: text, images, audio, machine-executable instructions, machine-readable data.

7. A computer-based, unmoderated content collaboration system, comprising:
(a) at least one network server, containing a host application and said content,
(b) one or more network clients, each containing a client application for interfacing with said host application,
(c) said host application having means for:
(1) requesting a modification to said content by a user,
(2) voting on the modification request by a multiplicity of users at said network clients,
(3) calculating an election result from said voting,
(4) applying said modification to said content in accordance with said election result,
whereby said content, in accordance with said election result, receives said modification without approval or implementation by a moderator.

8. The system of claim 7, further including, in said host application, means for rejecting said modification request when said modification request is determined to be incompatible with any other means of said host application.

9. The system of claim 7 wherein said means for voting includes predetermined program logic for administering a voting period, whereby said voting period commences and terminates without implementation by a moderator.

10. The system of claim 7 wherein said host application includes further means for alerting said multiplicity of users to said modification request.

11. The system of claim 7 wherein said host application includes an electronic messaging component, such that said multiplicity of users can discuss said modification request.

12. The system of claim 7 wherein said content comprises one or more of the following: text, images, audio, machine-executable instructions, machine-readable data.
